(19) United States
(12) Patent Application Publication
(10) Pub. No.: US 2015/0071702 A1
(43) Pub. Date: Mar. 12, 2015

(54) STRUCTURAL BODY AND PRODUCTION METHOD FOR THE SAME

(71) Applicant: Hitachi, Ltd., Tokyo (JP)

(72) Inventors: Matahiro KOMURO, Tokyo (JP); Naoya OKIZAKI, Tokyo (JP); Masafumi NOJIMA, Tokyo (JP)

(73) Assignee: HITACHI, LTD., Tokyo (JP)

(21) Appl. No.: 14/462,901

(22) Filed: Aug. 19, 2014

(30) Foreign Application Priority Data
Sep. 6, 2013 (JP) 2013-184602

(51) Int. Cl. C21D 1/04; B23K 37/00

(52) U.S. Cl. CPC C21D 1/04; B23K 37/00; C21D 2211/001; C21D 2211/005; C21D 2211/004; C22C 38/44
USPC 403/270; 148/108

(57) ABSTRACT

The present invention provides a structural body comprising a welded portion of a duplex stainless steel inclusive of an α phase and a Υ phase and an unwelded portion of the duplex stainless steel, wherein an X-ray diffraction intensity for the α phase is higher in a heat affected zone including the welded portion than in the unwelded portion and becomes a local maximum within the heat affected zone. The present invention provides aA production method for a structural body of a duplex stainless steel, wherein a heat affected zone including a welded portion of the structural body is heat-treated between 600° C. and 800° C. while a magnetic field of 1˜10 T is applied to the heat affected zone.

### FIELD OF INVENTION

The present invention relates to a structural body made of a duplex stainless steel (dual phase stainless steel) and a production method for the structural body.

### BACKGROUND OF INVENTION

The duplex stainless steel has a metallographic structure in which an austenite phase (Υ phase) and a ferrite phase (α phase) coexist, a property of being not susceptible to stress corrosion cracking and a high fracture toughness. The duplex stainless steel usually is a material of Fe alloyed with 22˜26% Cr, 4˜7% Ni and 1˜4% Mo (wt %).

Since the duplex stainless steel includes the ferrite phase, a σ phase having main components of Fe, Cr and Mo precipitates when it is heated into a temperature range from 600° C. to 950° C. If the duplex stainless steel has precipitates of the σ phase, both the fracture toughness and the impact strength of the duplex stainless steel become lower significantly. In addition, since concentrations of Cr and Mo in the vicinity of the σ phase become lower, corrosion resistance of a portion in the vicinity of the σ phase lowers as well. Especially there ought to be more precipitates of the σ phase in a welded portion that is heated more intensively to a higher temperature. Therefore, the duplex stainless steel is usually used in a temperature range that is not higher than 350° C.

There is a heat treatment method disclosed in JP09-111335A which is intended to inhibit the σ phase precipitating and prevent the mechanical properties and the corrosion resistance of the duplex stainless steel from worsening. In this disclosed heat treatment method, the duplex stainless steel is kept heated within a temperature range from 900° C. to 1040° C. and then cooled rapidly. JP10-287921A discloses a process in which a steel strip is held in a magnetic field and heat-treated in a temperature range that is not higher than a Curie temperature.

However, if the heat treatment method described in JP09-111335A is carried out on a structural body, the structural body is deformed and there remains residual stress in the structural body because the structural body is cooled rapidly after heated to a temperature higher than or equal to 900° C.

Since the heat treatment in JP10-287921 is carried out at a temperature that is not higher than the Curie temperature of the ferrite phase of the duplex stainless steel that has ferromagnetism, it is difficult to relieve the residual stress from the structural body.

The objective of the present invention is to enhance reliability of the structural body by inhibiting growth of the σ phase and removing residual stress in the structural body.

### SUMMARY OF INVENTION

The above mentioned objective is achieved by inventions described in claims.

The present invention enables inhibiting growth of the σ phase, removing residual stress in the structural body and enhancing reliability of the structural body.

### BRIEF DESCRIPTION OF DRAWINGS

FIG. 1 shows an example of a magnetization process apparatus.

FIG. 2 shows X-ray diffraction intensities of structural bodies after a magnetization process.

FIG. 3 shows an example of a magnetization process apparatus.

FIG. 4 shows an example of a magnetization process apparatus.

### DETAILED DESCRIPTION OF EMBODIMENTS

If the duplex stainless steel is heat-treated at a temperature that is higher than the Curie temperature of the ferrite phase included as a main phase and lower than 900° C., it is difficult to inhibit growth of the σ phase though residual stress is reduced. The σ phase grows as a reaction of the main phase of the ferrite phase being decomposed into the σ phase and the Υ phase progresses. The main phase of the ferrite phase has ferromagnetism while neither the σ phase nor the Υ phase is capable of being magnetized. Since the main phase of the ferrite phase has ferromagnetism, the magnetization gets oriented in a direction of a magnetic field when the magnetic field is applied. However spins of the other nonmagnetic phases have a much smaller tendency to get oriented with respect to the applied magnetic field than the main phase of the ferrite phase has when the magnetic field is applied.

The inventors heated a duplex stainless steel while applying a magnetic field and examined dependency of a magnetization of a duplex stainless steel on the heating temperature. It turns out that the Curie temperature Tc of the main phase of the ferrite phase in the duplex stainless steel becomes 20° C. higher when the duplex stainless steel is heat-treated while a magnetic field larger than 1 T is applied, that there is a magnetic transformation point between 700° C. and 800° C. across which the magnetization changes at a smaller change rate than the main phase does when the duplex stainless steel is heat-treated while a magnetic field larger than 1 T is applied, and that the saturated magnetization of the duplex stainless steel that is heat-treated being kept in a magnetic field not smaller than 1 T is larger than one heat-treated without any magnetic field applied.

According to the results above mentioned, it ought to be understood that decomposition of the main phase of the ferrite phase into the σ phase and the Υ phase can be inhibited after the duplex stainless steel is heat-treated between 600° C. and 800° C., if the duplex stainless steel is kept in a magnetic field from 1 T to 10 T during the heat treatment. The reason why the main phase of the ferrite phase is not easily decomposed is that the structure of the main phase of the ferrite phase is stabilized after it is kept in the magnetic field within a range from 1 T to 10 T during the heat treatment. It turns out that the magnetization of the ferrite phase having been heat-treated with the magnetic field being applied does not becomes 0, which indicates that there remain local portions having ferromagnetism in the ferrite phase at 700° C. Spins in the ferrite phase tend to get oriented in parallel with the magnetic field and the structure of the ferrite phase is stabilized. When the duplex stainless steel is heat-treated in the magnetic field higher than or equal to 1 T, this effect becomes significant and more spins get oriented in a direction of the magnetic field, which reduces the free energy of the ferrite phase compared with spins in random directions. As a result, ferromagnetism of the ferrite phase is maintained at higher temperatures.

Since the ferrite phase showing ferromagnetism is stabilized after heat-treated in the magnetic field, conversion of the ferrite phase to other phases having a smaller magnetization is inhibited. The heating temperature to obtain this inhibiting effect is preferably within a temperature range that is not lower than the Curie temperature of the main phase and not higher than a magnetization disappearing temperature when a magnetic field is applied and between 600° C. and 800° C. for the duplex stainless steel.

An embodiment of the present invention is explained in detail with reference to a structural body formed by welding the duplex stainless steel.

### EXAMPLE 1

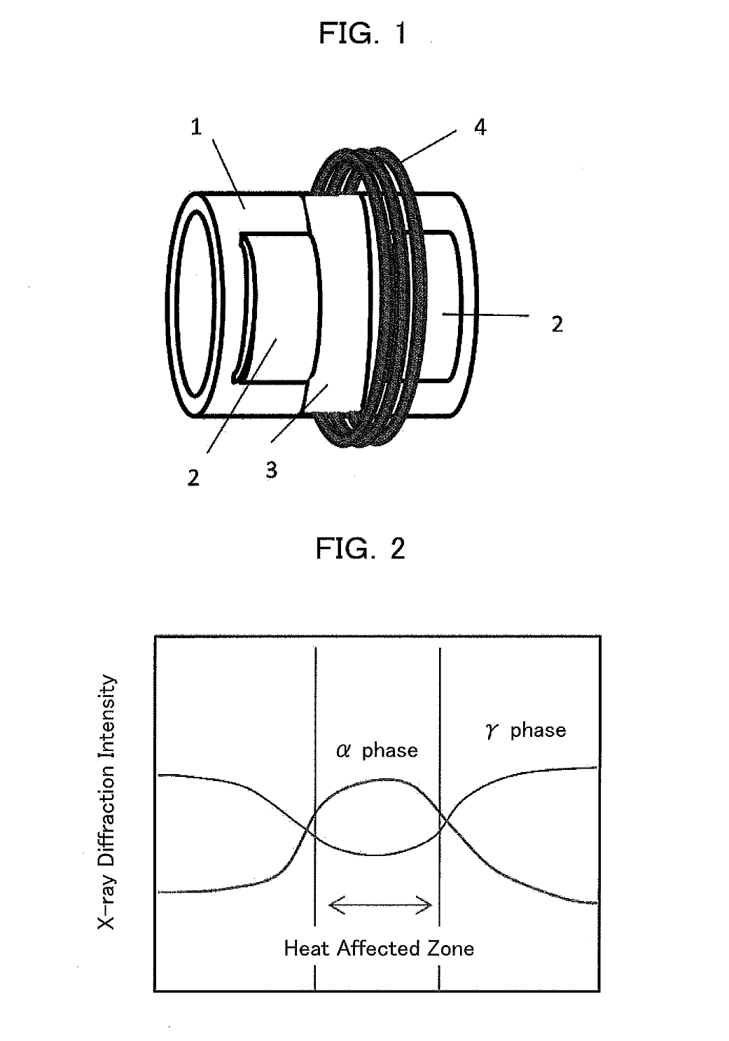

A structural body was formed by welding the duplex stainless steel whose composition is Fe—25.28 Cr—7.01 Ni—3.90 Mo—0.99 Mn—0.43 Cu—0.13 W—0.024 C—0.27 N (wt %). Since a welded portion of the duplex stainless steel was heated to a temperature equal to or higher than the melting temperature of the duplex stainless steel and rapidly cooled, residual strain is created in the welded portion by thermal stress. This residual strain could result in low temperature fracture. Therefore the residual strain has to be relieved. In order to relieve the residual strain, the welded portion was heated to a sufficiently high temperature below the melting temperature. FIG. 1 shows an example of an apparatus in which welded members are heated and simultaneously kept in a magnetic field. A magnetic field treatment apparatus includes a magnetic field introduction yoke 2 and a coil 4 and heats a duplex stainless pipe 1 through a high frequency magnetic field generated by the coil 4 disposed outside the duplex stainless pipe 1. A static magnetic field introduced through the magnetic field introduction yoke 2 is applied to a heated welded portion 3 and is larger than the high frequency magnetic field applied.

The heating temperature of the welded portion of the duplex stainless steel pipe was set to 700° C. The pipe was heated to 700° C. at a heating speed of 10° C./minute, kept at 700° C. for 30 minutes and then cooled to 400° C. at a cooling speed of 50˜100° C./minute and further to a room temperature. A static magnetic field of 2 T whose direction is perpendicular to the radial directions of the pipe was applied to the pipe while the temperature of the pipe is equal to or higher than 400° C. during the heat treatment.

The inventors have investigated charpy impact values of the duplex stainless steel before the heat treatment and both of the duplex stainless steel to which the static magnetic field was applied during the heat treatment and the duplex stainless steel to which no static magnetic field was applied during the heat treatment. The following results were obtained. The charpy impact value of the duplex stainless steel before the heat treatment was 200 J/cm². The charpy impact value of the duplex stainless steel to which a static magnetic field of 2 T had been applied during the heat treatment was 190 J/cm². The charpy impact value of the duplex stainless steel to which no static magnetic field had been applied during the heat treatment was 60 J/cm². Accordingly, there is an outstanding effect of the static magnetic field being applied during the heat treatment on the charpy impact value.

The σ phase was observed in the duplex stainless steel that was kept heated at 700° C. for 30 minutes with no static magnetic field being applied. On the other hand, no growth of the σ phase was observed in the duplex stainless steel that was kept heated at 700° C. for 30 minutes with the static magnetic field of 2 T. This result is attributed to the ferrite phase becoming more stabilized by the static magnetic field being applied.

The effect of the static magnetic field being applied is further explained as follows. The static magnetic field was applied through the magnetic field introduction yoke 2 using a permanent magnet or an electromagnet. The applied static magnet field in a longitudinal direction of the pipe was applied to the welded portion 3 and forms a closed magnetic circuit through the magnetic field introduction yokes 2 disposed on both sides of the welded portion 3. The longitudinal direction of the pipe corresponds to a direction in which the pipe was rolled and crystal grains of ferrite and crystal grains of austenite are elongated in the longitudinal direction. There remains a metallographic structure of similar elongated crystal grains in the vicinity of the welded portion. When the static magnetic field is applied during the heat treatment, demagnetization field is relatively small and the magnetization effect is easily obtained.

In the case of the duplex stainless steel pipe to which no static magnetic field was applied, the σ phase started to precipitate from an interface between the ferrite phase and the austenite phase and grew into the ferrite phase. In the case of the duplex stainless steel pipe to which the static magnetic field of 2 T was applied, the magnetization of ferromagnetic ferrite phase or spins of local portions in the ferrite phase become oriented in parallel with the applied static magnetic field to decrease a free energy of ferrite phase. Due to this effect, the Curie temperature of the ferrite phase of the duplex stainless steel to which no static magnetic field was applied is 500° C. while the Curie temperature of the ferrite phase of the duplex stainless steel to which the static magnetic field of 2 T was applied rises to 520° C. The rise in the Curie temperature becomes significant if the applied magnetic field is equal to or higher than 0.5 T.

If the magnetic field intensity of the static magnetic field exceeds 10 T, diffusion induced by the magnetic field becomes significant and a phase of a higher magnetization is formed. To be specific, if the magnetic field intensity of the static magnetic field exceeds 10 T, concentrations of Cr and Mo both included in the ferrite phase decrease and the magnetization of the ferrite phase becomes larger, which decreases the free energy of the ferrite phase. This diffusion causes Cr and Mo to diffuse into other phases than the ferrite phase, which helps with growth of the σ phase containing a higher concentration of Cr. Therefore the applied magnetic field intensity is preferably equal to or lower than 10 T.

Conditions of the heat treatment and the applied static magnetic field in this example are further explained. There remains stress in a welded portion between weld joints and it is effective to have this welded portion heated at 700° C. for more than 10 minutes in order to relieve the residual stress. The heating temperature of the welded portion to be high-frequency heated is set to 700° C., the applied static field is set to 2 T, the heating speed is set to 10° C./minute and the heating atmosphere is set to an Ar atmosphere. If the heating speed is set to 5° C./minute, the heating time becomes so long that the σ phase easily precipitates and grows. If the cooling speed is less than 50° C./minute, the σ phase easily precipitates and grows. The direction in which the static magnetic field is applied is most effectively a direction perpendicular to the radial directions. Since the diffusion speed is relatively low below 400° C., the static magnetic field is applied while the temperature is equal to or higher than 400° C., although it is possible to apply the static magnetic field before starting heating.

### EXAMPLE 2

A rolled strip of the duplex stainless steel, whose composition is Fe—25 Cr—7 Ni—3.6 Mo—0.8 Mn—0.01 C—0.27 N (wt %) and whose 0.2% yield strength is 700 N/mm², was used. As a welding process and a subsequent heat treatment process are performed on the rolled strip, an impact value of the rolled strip significantly lowers due to precipitation of such an intermetallic compound as the a phase precipitates. It is necessary to inhibit growth of such an intermetallic compound as the σ phase to prevent the impact value from lowering. The inventors have found that it is possible to inhibit growth of the σ phase in a rolled strip by performing the heat treatment while applying a static magnetic field that is in parallel with a rolling direction in which the rolled strip is rolled.

The above mentioned rolled strip consists more or less of laminated layers of the α phase and laminated layers of the Υ phase and the Curie temperature of the α phase is 500° C. When the duplex stainless steel is used for a structural body, the structural body includes a welded portion. A heat affected zone created by welding is a portion in which a welded portion is completely included. In order to relieve residual stress in the heat affected zone, the heat affected zone is heated. The heating temperature is preferably higher than the Curie temperature of the α phase that is 500° C. and not higher than the Curie temperature of iron that is 770° C. In this example, the heat affected zone was kept heated at 600° C. for 1 hour and then cooled at a cooling speed of 50° C./minute.

Only the heat affected zone was heated and a magnetic field of 2 T substantially in parallel with the rolling direction was applied through yokes to the heat affected zone while the heat affected zone was heated. When the magnetic field is applied, the α phase becomes stabilized and precipitation of the σ phase is inhibited. After the heat affected zone is cooled, a volume ratio of the α phase is higher than a volume ratio of the Υ phase. FIG. 2 shows distribution of X-ray diffraction (XRD) intensities. An XRD intensity of the α phase has a local maximum at the heat affected zone, where the XRD intensity of the α phase is higher than an XRD intensity of the Υ phase. In other portions (non-welded portion) than the heat affected zone, the XRD intensity of the α phase is lower than the XRD intensity of the Υ phase. On the other hand, the XRD intensity of the Υ phase has a local minimum in the heat affected zone. The heat affected zone is a portion into which heat generated by welding is transmitted and inflection points from which the XRD intensity starts abruptly increasing correspond to a border of the heat affected zone.

The influence of the applied magnetic field is explained as follows. If the applied magnetic field is equal to or higher than 2 T when the heating temperature on the heat affected zone is 600° C., the Curie temperature of the α phase becomes higher and the Curie temperature of a part of the α phase is 700˜770° C. This is due to stabilization of the α phase and the magnetization of the part of the α phase is kept at higher temperatures. When spins in the α phase get oriented in parallel with one another and the magnetization of the α phase becomes larger while the magnetic field is being applied, the free energy of the α phase lowers and the α phase is not easily decomposed into the σ phase whose magnetization is almost 0. It turns out that the formed α phase has a composition of Fe—1˜15 Cr—1˜4 Ni—1˜2 Mo, a higher Curie temperature and a magnetization that is 0.01˜1 emu/g at 700° C.

If the applied magnetic field is weaker than 2 T, the effect of the Curie temperature of the α phase becoming high is so small that the α phase has a magnetization at 700° C. that is smaller than 0.01 emu/g and that decomposition of the α phase into the σ phase is hardly inhibited. The effect of the Curie temperature of the α phase becoming high is highest if the magnetic field is applied in parallel with the rolling direction of the rolled strip. Since the rolled strip has crystal grains of the α phase that are elongated in the rolling direction, demagnetizing field is smaller in the rolling direction. If the magnetic field is applied in the direction within ±30° relative to the rolling direction, the effect of the magnetic field is sufficiently large, the α phase is most stable and precipitation of the σ phase is inhibited. If the magnetic field is applied in a direction making an angle of 45° with the rolling direction, the effect of the magnetic field is equal to the effect obtained from the magnetic field in parallel with the rolling direction on the condition that the applied magnetic field has 30˜60% higher magnetic field intensity. If the heating temperature is equal to or lower than the Curie temperature of the α phase which has not been heated, the magnetic field is applied over the whole crystal grain of the α phase and magnetic field induced diffusion of such σ phase forming elements as Cr and Mo does not easily occur. On the other hand, if the magnetic field is applied at the heating temperature that is higher than the Curie temperature (a temperature for a local maximum of a differential value obtained by differentiating the magnetization with respect to the temperature) of the α phase which has not been heated, the magnetization is higher in portions in the α phase where the concentrations of Cr and Mo are relatively low and magnetic flux density is higher in the portions. As a result, Cr and Mo diffuse from the α phase into the Υ phase. Therefore, the concentrations of Cr and Mo in the α phase lower and precipitation of the σ phase does not easily occur. Moreover, Ni diffuses from the Υ phase into the α phase, which increases the magnetization of the α phase.

The same effect for this example as above mentioned has been found with any of duplex stainless steels having material compositions of Fe—22 Cr—1.4 Ni—0.3 Mo—5.0 Mn—0.02 C—0.2 N (wt %) and Fe—24 Cr—3.9 Ni—0.3 Mo—1.6 Mn—0.01 C—0.1 N (wt %), which are different material compositions from one used in this example.

### EXAMPLE 3

The duplex stainless steel containing Cr and Mo includes a couple of coexisting phases of the ferrite phase (α phase) and the austenite phase (Υ phase) and has properties of a high strength and a high corrosion resistance. The Cr concentration is within a range of 20˜26 wt % and the Mo concentration is within a range of 0.3˜4 wt %. Both the Cr concentration and the Mo concentration are higher in the α phase than in the Υ phase.

When a rolled strip of this duplex stainless steel is welded, the rolled strip is welded with a static magnetic field being applied. For example, a static magnetic field of 2 T is applied in the rolling direction in this example while the rolled strip is being cooled after welding. Then the free energy of the α phase of the stainless steel is lower with a high magnetization of the α phase of the stainless steel kept in parallel with the direction of the applied magnetic field and the resultant magnetization of the α phase of the stainless steel is higher than that of the α phase of the stainless steel being cooled without a magnetic field applied. Since the high magnetization is maintained in the α phase, concentrations of Cr and Mo in the α phase of the stainless steel cooled with the magnetic field applied become lower than those in the α phase of the stainless steel cooled without the magnetic field applied. Because differences in the concentrations of Cr and Mo between the α phase and the Υ phase become smaller, the σ phase does not easily precipitate.

Since the magnetic field is not applied during the welding process and is applied during the cooling process after welding, the α phase comes to have such a composition that the σ phase does not easily precipitate. This effect of the σ phase not easily precipitating is valid during a subsequent heat treatment if no magnetic field is applied. If a magnetic field weaker than 2 T is applied, the magnetic field induced diffusion of Cr and Mo does not occur so significantly that the concentrations of Cr and Mo in the α phase is hardly different from those for the case in which no magnetic field is applied. If the applied magnetic field is equal to or higher than 2 T and equal to and lower than 10 T, the concentrations of Cr and Mo decrease respectively by 1.5 wt % and 1.0 wt % and become closer to those in the Υ phase. Due to the magnetic field induced diffusion of Cr and Mo, the concentrations of Cr and Mo in the α phase, which are σ phase forming elements, decrease and precipitation of the σ phase is inhibited.

### EXAMPLE 4

A rolled strip of a duplex stainless steel, which has a composition of Fe—25 Cr—7 Ni—3.6 Mo—1.1 V—0.8 Mn—0.01 C—0.27 N (wt %) and a 0.2% yield strength of 600 N/mm², was used. The rolled strip of this composition consists more or less of laminated layers of the α phase and laminated layers of the Υ phase and the Curie temperature of the α phase is 600° C. When the duplex stainless steel is used for a structural body, the structural body includes a welded portion. A heat affected zone created by welding is a portion in which a welded portion is completely included. In order to relieve residual stress in the heat affected zone, the heat affected zone is heated. The heating temperature is preferably higher than the Curie temperature of the α phase that is 600° C. and not higher than the Curie temperature of 830° C. of the Fe—V alloy. In this example, the heat affected zone was kept heated at 700° C. for 1 hour and then cooled at a cooling speed of 50° C./minute.

Only the heat affected zone was heated and a magnetic field of 2 T substantially in parallel with the rolling direction was applied through yokes to the heat affected zone while the heat affected zone was heated. When the magnetic field is applied, the α phase becomes stabilized and precipitation of the σ phase is inhibited. After the heat affected zone is cooled, a volume ratio of the α phase is higher than a volume ratio of the Υ phase.

The influence of the applied magnetic field is explained as follows. If the applied magnetic field is equal to or higher than 2 T when the heating temperature on the heat affected zone is 700° C., the Curie temperature of the α phase becomes higher and the Curie temperature of a part of the α phase is 750˜820° C. This is due to stabilization of the α phase and a higher concentration of V in the α phase. As a result, the magnetization of the part of the α phase is kept at higher temperatures. When spins in the α phase get oriented in parallel with one another and the magnetization of the α phase becomes larger while the magnetic field is being applied, the free energy of the α phase decreases and the α phase is not easily decomposed into the σ phase whose magnetization is almost 0. It turns out that the formed α phase has a composition of Fe—1˜15 Cr—1˜4 Ni—1˜2 Mo—0.5˜2 V, a higher Curie temperature and a magnetization that is 0.01˜5 emu/g at 700° C.

If the applied magnetic field is weaker than 2 T, the effect of the Curie temperature of the α phase becoming higher is so small that the α phase has a magnetization that is smaller than 0.01 emu/g at 700° C. and that decomposition of the α phase into the σ phase is hardly inhibited. The effect of the Curie temperature of the α phase becoming higher is largest when the magnetic field is applied in parallel with the rolling direction of the rolled strip. Since the rolled strip has crystal grains of the α phase that are elongated in the rolling direction, demagnetizing field is smaller in the rolling direction. If the magnetic field is applied in the direction within ±30° relative to the rolling direction, the effect of the magnetic field is sufficiently large, the α phase is most stable and precipitation of the σ phase is inhibited. If the magnetic field is applied in a direction making an angle of 45° with the rolling direction, the effect of the magnetic field can be equal to the effect obtained from the magnetic field applied in parallel with the rolling direction on the condition that the applied magnetic field has 30˜60% higher magnetic field intensity.

If the heating temperature is equal to or lower than the Curie temperature of the α phase which has not been heated, the magnetic field is applied over the whole crystal grain of the α phase and magnetic field induced diffusion of such σ phase forming elements as Cr and Mo does not easily occur. On the other hand, if the magnetic field is applied at the heating temperature that is higher than the Curie temperature (temperature for a local maximum of the differential value obtained by differentiating the magnetization with respect to temperature) of the α phase which has not been heated, the magnetization is higher in portions in the α phase where the concentrations of Cr and Mo are relatively low, the Curie temperature is higher due to uneven distribution of V and magnetic flux density is higher in the portions. As a result, Cr and Mo diffuse from the α phase into the σ phase. Therefore, the concentrations of Cr and Mo in the α phase lower and precipitation of the σ phase does not easily occur.

The same effect as one on this example has been found with any of duplex stainless steels having material compositions of Fe—22 Cr—1.4 Ni—0.3 Mo—5.0 Mn—1.2 V—0.02 C—0.2 N (wt %) and Fe—24 Cr—3.9 Ni—0.3 Mo—1.6 Mn—1.5 V—0.01 C—0.1 N (wt %), which are different material compositions from one used in this example. If V is added to the duplex stainless steel and the V concentration is more than 5 wt %, precipitation of the σ phase occur due to uneven distribution of V. Therefore, V is added to the duplex stainless steel preferably in such a manner that the concentration of V is within a range of 0.2˜5 wt %. When the concentration of V is smaller than 0.2 wt %, the Curie temperature hardly rises.

### EXAMPLE 5

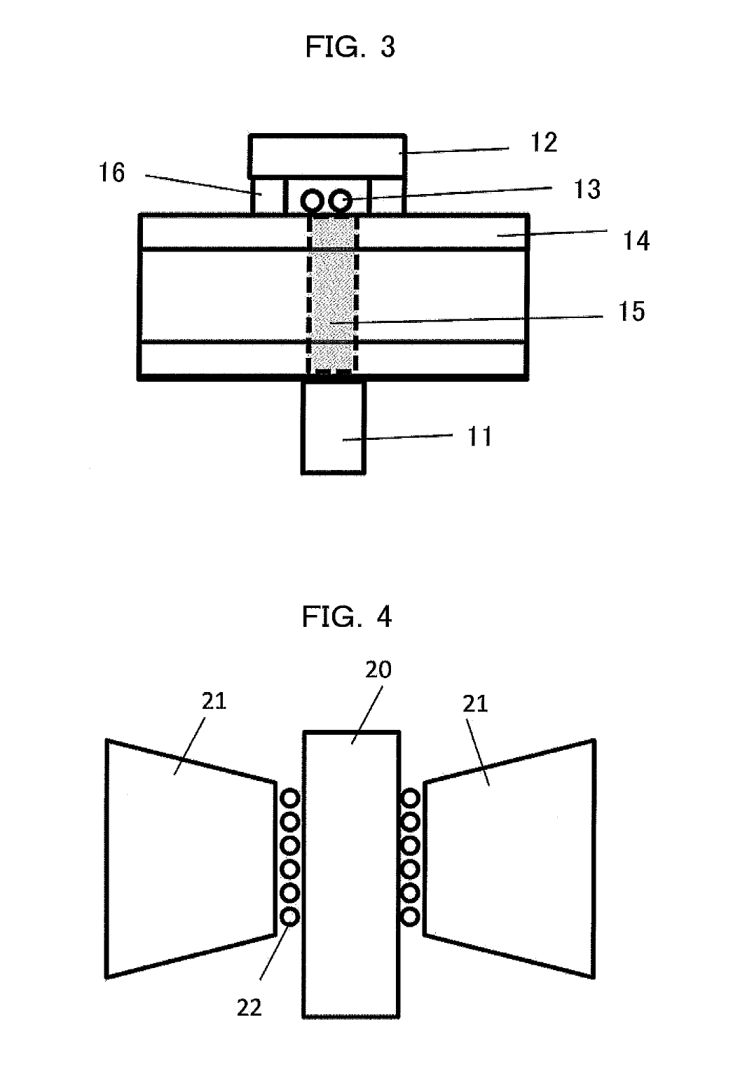

FIG. 3 shows an example of a magnetization process apparatus. Since there is a heat affected zone 15 in a duplex stainless pipe 14 that is a part of a duplex stainless steel body, the heat affected zone 15 is heat-treated in a magnetic field in order to relieve strain in the heat affected zone 15 or reform the metallographic structure. An eddy current heating coil 13 for a high frequency heating is placed for a heat source and a static magnetic field is applied through a permanent magnet 12. A ratio of the α phase in the heat affected zone is measured with a ferrite scope 11. In order to perform the magnetic field treatment within a temperature range where the α phase is not decomposed, the magnet field intensity and the heating temperature are regulated based on an output of the ferrite scope by disposition of the permanent magnet and an output of the high frequency heating power source while checking through the ferrite scope that no decomposition of the α phase occurs.

### EXAMPLE 6

The duplex stainless steel containing Cr and Mo includes a couple of coexisting phases of the ferrite phase (α phase) and the austenite phase (Υ phase) and has properties of a high strength and a high corrosion resistance. The duplex stainless steel contains 20˜26 wt % of Cr and 0.3˜4 wt % of Mo. The duplex stainless steel is heated at 1050° C. for 0.5 hours for solution treatment and cooled at a cooling speed within a range from 50° C./minute to 150° C./minute. While the duplex stainless steel is being cooled, a static magnetic field that is equal to or higher than 2 T is applied. Due to the magnetic field being applied, the magnetization of the α phase increases and Cr and Mo included in the α phase diffuse into the Υ phase. Because the magnetization of the α phase increases, the Curie temperature of the α phase becomes higher.

When a rolled strip of this duplex stainless steel is welded, the rolled strip is welded with a static magnetic field being applied. For example, a static magnetic field of 1 T is applied in the rolling direction in this example while the rolled strip is being cooled after welding. Then the free energy of the α phase of the stainless steel becomes lower with a high magnetization of the α phase of the stainless steel kept in parallel with the direction of the applied magnetic field and the resultant magnetization of the α phase of the stainless steel becomes higher than that of the α phase of the stainless steel being cooled without a magnetic field applied. Since as high a magnetization as possible is maintained in the α phase, concentrations of Cr and Mo in the α phase of the stainless steel cooled with the magnetic field applied become lower than those in the α phase of the stainless steel cooled without the magnetic field applied. Because differences in the concentrations of Cr and Mo between the α phase and the Υ phase become smaller, the σ phase does not easily precipitate.

Since the magnetic field is not applied during the welding process but applied during the cooling process after welding, the α phase has such a composition that the σ phase does not easily precipitate. This effect of the σ phase not easily precipitating is valid during a subsequent heat treatment if no magnetic field is applied. If a magnetic field weaker than 2 T is applied, the magnetic field induced diffusion of Cr and Mo does not occur so significantly that the concentrations of Cr and Mo in the α phase is hardly different from those for the case in which no magnetic field is applied. If the applied magnetic field is equal to or higher than 1 T and equal to and lower than 10 T, concentrations of Cr and Mo decrease respectively by 1.5 wt % and 1.0 wt % and become closer to those in the Υ phase. Due to the magnetic field induced diffusion of Cr and Mo, the concentrations of Cr and Mo in the α phase, which are σ phase forming elements, decrease and precipitation of the σ phase is inhibited.

### EXAMPLE 7

A stainless steel material used includes an α phase of bcc structure having a Curie temperature of 500° C. and a Υ phase of fcc structure that is nonmagnetic at 20° C., which constitute main phases. While a static magnetic field is being applied, this stainless steel material is kept heated at a high temperature and cooled rapidly. The stainless steel material is heated to a temperature equal to or higher than the Curie temperature and cooled at a cooling speed equal to or higher than 50° C./minute in the temperature range that is equal to or lower than the Curie temperature. When the magnetic field equal to or higher than 1 T, neither a σ phase nor a χ phase easily precipitates. A pipe after welded is heat-treated in a magnetic field and embrittlement caused by the σ phase is inhibited.

A heat-treated strip 20 whose main phases are a α phase and a Υ phase was heat-treated with a magnetic field applying and heating apparatus as is shown in FIG. 4. A heater 22 was disposed between the heat-treated material and an electromagnet 21 and a welded portion or a heat affected zone of the heat-treated material was heated to 750° C. and kept at this temperature for 5 minutes. A static magnetic field of 2 T was applied by the electromagnet 21 during the heating and cooling process. The heat-treated material was water cooled at a cooling speed of 200° C./minute in a temperature range down to the Curie temperature in an atmosphere into which an inert gas is introduced.

During the heat treatment above mentioned, a part of the σ phase or the χ phase is transformed to the α phase of bcc structure. This transformation occurs due to the following reason. Since a phase having a higher magnetization is stabilized at high temperatures due to the applied static magnetic field, a phase having a lower magnetization is transformed to other phase having a higher magnetization. A nonequilibrium phase can be created through a heat treatment and a rapid cooling in a magnetic field.

Critical parameters for the present example are a heating temperature, a heating speed, a keeping time at a maximum temperature, a cooling speed and a magnetic field intensity. A nonequilibrium ferromagnetic phase having a different magnetic transformation point from that of a ferromagnetic phase before the heat treatment can be formed in such parameter ranges as the heating temperature within a range of 550˜850° C., the heating speed within a range of 10˜100° C./minute, the keeping time at the maximum temperature within a range of 1˜10 minutes, the cooling speed within a range of 50˜500° C./minute and the magnetic field intensity within a range of 0.5˜30 T. These value ranges are dependent on the material composition, the grain size and the magnetization orientation, and if the cooling speed is equal to or less than 20° C./minute, the nonequilibrium ferromagnetic phase is not formed and the heat-treated strip becomes embrittled.

In order to enable the cooling speed within a range of 50˜500° C./minute, the heater should be moved after the heat-treated strip is kept at the maximum temperature and refrigerant gas is introduced. When the heat-treated strip is so thick that it is cooled at a lower speed, liquid for cooling is made to flow in addition to the refrigerant. A magnetic phase indicating a magnetic transformation point that is not observed before the heat treatment is created.

It is possible to create the magnetic field induced nonequilibrium phase that is able to grow while a heat-treated strip is being cooled not only in the duplex stainless steel, but also in such materials as soft magnetic materials, hard magnetic materials, thermoelectric materials, super-conductive materials, stainless steel materials, tool steels and wear resistant materials.

What is claimed:

1. A structural body comprising a welded portion of a duplex stainless steel inclusive of an α phase and a Υ phase and an unwelded portion of the duplex stainless steel, wherein an X-ray diffraction intensity for the α phase is higher in a heat affected zone including the welded portion than in the unwelded portion and becomes a local maximum within the heat affected zone.

2. The structural body as described in claim 1, wherein an X-ray diffraction intensity for the Υ phase is lower in the heat affected zone of the duplex stainless steel than in the unwelded portion and becomes a local minimum within the heat affected zone.

3. The structural body as described in claim 1, wherein a volume ratio of the α phase in the heat affected zone is higher than a volume ratio of the Υ phase in the heat affected zone.

4. The structural body as described in claim 1, wherein a Curie temperature of the duplex stainless steel is within a range of 750˜820° C.

5. The structural body as described in claim 1, wherein a magnetization of the α phase in the duplex stainless steel is 0.01˜1 emu/g at 700° C.

6. A production method for a structural body of a duplex stainless steel, wherein a heat affected zone including a welded portion of the structural body is heat-treated between 600° C. and 800° C. while a magnetic field of 1˜10 T is applied to the heat affected zone.
